(19) United States
(12) Patent Application Publication
(10) Pub. No.: US 2019/0263407 A1
(43) Pub. Date: Aug. 29, 2019

(54) Control Strategy for a Hybrid Vehicle for Reduced Emission Values

(71) Applicant: CPT Group GmbH, Hannover (DE)

(72) Inventor: Andreas Heinrich, Laaber (DE)

(73) Assignee: CPT Group GmbH, Hannover (DE)

(21) Appl. No.: 16/340,852

(22) PCT Filed: Oct. 5, 2017
(86) PCT No.: PCT/EP2017/075393

§ 371 Date: Apr. 10, 2019

(30) Foreign Application Priority Data
Oct. 14, 2016 (DE) 10 2016 220 134.4
Dec. 22, 2016 (DE) 10 2016 225 953.9

(51) Int. Cl. B60W 30/188; B60W 10/06; B60W 10/08

(52) U.S. Cl. CPC B60W 30/1886; B60W 10/06; B60W 2710/085; B60W 2510/305; B60W 10/08

(57) ABSTRACT

Various embodiments include a method for operating a motor vehicle having a hybrid drive train with an internal combustion engine and an electric motor comprising: defining a desired required torque in response to a momentary additional torque requirement and in the presence of a predefined activation condition; determining a target torque depending on the required torque; calculating a difference between the target torque and the momentarily provided actual torque; initially generating an additional torque equivalent to the difference using the electric motor; reducing the additional torque provided by the electric motor within a predefined time interval; and increasing a portion of the torque provided by the internal combustion engine to the same extent in the same time interval using a real-time control system.

### CROSS-REFERENCE TO RELATED APPLICATIONS

This application is a U.S. National Stage Application of International Application No. PCT/EP2017/075393 filed Oct. 5, 2017, which designates the United States of America, and claims priority to DE Application No. 10 2016 220 134.4 filed Oct. 14, 2016 and DE Application No. 10 2016 225 953.9 filed Dec. 22, 2016, the contents of which are hereby incorporated by reference in their entirety.

### TECHNICAL FIELD

The present disclosure relates to motor vehicles. Various embodiments include methods and/or systems for operating a motor vehicle with a hybrid drive train.

### BACKGROUND

A motor vehicle with a hybrid drive train comprises at least one internal combustion engine and at least one electric motor. Some hybrid vehicles allow operation purely from the internal combustion engine, or an operating state in which the electric motor and internal combustion engine together supply the drive torque. In such vehicles, the internal combustion engine is often used for longer distances while the electric motor is used for start-up or for short acceleration processes. Often, the support from the electric motor is also used to provide comfort functions such as air conditioning. Brief power increases of the internal combustion engine are normally unfavorable, since the emission values rise disproportionately at this time. In order to reduce this effect, the electric motor is engaged for support. The power gradients of the internal combustion engine may then be flatter.

Automatic control of the electric motor and internal combustion engine in combined operation is however very complex and subject to many influencing variables which are extremely dynamic. Therefore, the behaviour of the vehicle differs when all variables are taken into account. A real-time calculation with all disturbance variables is extremely calculation-intensive and often cannot be resolved unambiguously.

### SUMMARY

The present disclosure describes a simplified control strategy for a combined operation of the electric motor and internal combustion engine. For example, some embodiments of the teachings herein include a method for operating a motor vehicle having a hybrid drive train, having at least one internal combustion engine and at least one electric motor, wherein in a first possible operating state, a drive torque is generated solely by the internal combustion engine, and in a second possible operating state, the drive torque of the motor vehicle is generated by the internal combustion engine and the electric motor together; wherein in the first or second operating state, in the event of a momentary additional torque requirement and in the presence of at least one predefined activation condition, a desired required torque (M_{Wunsch}) is defined and, depending on the required torque, a target torque (M_{Soll}) is determined, and a difference Δ between the target torque and the momentarily provided actual torque (M_{Ist}), and the difference Δ is initially provided as additional torque (M_{EM}) by the electric motor, and the additional torque (M_{EM}) provided by the electric motor is reduced within a predefined time interval c, wherein the torque provided by the internal combustion engine (M_{VM}) is increased to the same extent in the same time interval c by means of a real-time control system.

In some embodiments, the target torque (M_{Soll}) is determined as a function of the desired torque (M_{Wunsch}) and the momentary status data of the internal combustion engine and/or the electric motor.

In some embodiments, the target torque (M_{Soll}) determined does not exceed a characteristic curve of the internal combustion engine.

In some embodiments, the additional torque (M_{EM}) provided by the electric motor is reduced to zero within a predefined time interval c.

In some embodiments, the at least one predefined activation condition for the motor vehicle is fixedly set.

In some embodiments, the at least one predefined activation condition is defined by predefined operating regions in maps of the internal combustion engine and/or electric motor, and/or by permitted energy store states and/or pedal states or gradients.

In some embodiments, the at least one predefined activation condition is stored in the motor vehicle, and in the case of an additional torque request it is checked whether an activation condition is fulfilled, in that the momentary status data of the internal combustion engine and or electric motor, and/or current energy store status data are compared with the at least one activation condition.

In some embodiments, the predefined time interval c is a value which is fixedly set for the motor vehicle.

In some embodiments, the predefined time interval c is calculated dynamically from the momentary status data of the internal combustion engine and/or electric motor.

In some embodiments, a linear profile is predefined for the reduction of the additional torque (MEM) provided by the electric motor within the predefined time interval c.

As another example, some embodiments include a control device for a motor vehicle with a hybrid drive train, with at least one internal combustion engine and an electric motor, wherein the engine control device comprises a processor device which is configured to perform a method as claimed in any of the preceding claims.

In some embodiments, the control device stores and processes momentary status data of the electric motor and internal combustion engine and controls the performance of the internal combustion engine and electric motor.

As another example, some embodiments include a motor vehicle with a hybrid drive train and a control device as described above.

### BRIEF DESCRIPTION OF THE DRAWINGS

The teachings herein are explained in more detail below with reference to the exemplary embodiments shown in the figures. The drawings show schematically:

FIG. 1 the sequence of the method using various torque curves for the internal combustion engine and electric motor, with and without performance of the method incorporating the teachings herein; and

FIG. 2 a block flow diagram to illustrate the real-time control strategy according to an exemplary embodiment of the method incorporating the teachings herein.

### DETAILED DESCRIPTION

Some embodiments include a method for operating a motor vehicle with a hybrid drive train. The hybrid drive train comprises at least one internal combustion engine and an electric motor. In a first possible operating state, the drive torque is provided solely by the internal combustion engine, whereas in a second possible operating state, the drive torque is provided by the internal combustion engine and electric motor together. The method according to the invention provides that in the first or second operating state, in the event of a momentary additional power request and in the presence of at least one predefined activation condition, a desired required torque is established. A target torque is determined depending on the required torque, and a difference Δ between the target torque and the momentary actual torque provided is determined. In some embodiments, other possible limitations are taken into account when determining the target torque.

In some embodiments, the difference Δ is initially provided as an additional torque by the electric motor. This additional torque provided by the electric motor is reduced within a predefined time interval c, wherein the torque provided by the internal combustion engine is increased to the same extent in the same time interval c by means of a real-time control system.

A momentary additional power request may be given for example by the driver, for example by pressing the accelerator, or by a driver assistance system. The method may be used in a first operating state, i.e. the internal combustion engine generates the drive torque for the motor vehicle. It could also be used when the vehicle is in the second operating state, i.e. when both the internal combustion engine and the electric motor contribute to the drive torque of the vehicle. In this case however, suitably the maximal drive torque of the electric motor is not yet exhausted so that it is possible for the electric motor to provide an additional torque. This may be taken into account via suitable activation conditions.

Using the activation conditions, operating states may be defined in which the method may usefully be applied. Suitable activation conditions are for example appropriate speed ranges of the vehicle, appropriate operating states of the internal combustion engine and electric motor, and suitable charge states of a vehicle battery which feeds the electric motor, and suitable combinations thereof. In addition, status information on the vehicle pedals, injection quantities and their gradients, rotation speeds and speed changes may be taken into account in the activation conditions.

A torque request by the driver or a driver assistance system defines a desired required torque. It may be that this required torque cannot be achieved because it exceeds the power capacity of the motors or is unsuitable for other reasons. Depending on the required torque therefore, according to the invention a target torque is first determined. This may for example prevent the internal combustion engine from entering an operating range which is unfavourable for emissions. The required torque requested is therefore corrected, to a certain extent, to a suitable but maximum possible target torque. On this basis, the difference Δ between the target torque and the momentarily provided actual torque, i.e. that momentarily provided by the motors, is determined.

In some embodiments, the difference Δ is initially provided as an additional torque by the electric motor. This may take place immediately, i.e. without unnecessary delay. The desired torque is therefore corrected to the target torque immediately available. It is easier for the electric motor to provide rapid torque increases than for an internal combustion engine. In some embodiments, this additional torque is however reduced again within a predefined time interval c which preferably is selected as short as possible. The additional power of the electric motor is thus reduced again within the time c although the torque request is sustained.

The real-time control strategy now ensures that while the power of the electric motor is being reduced, the power of the internal combustion engine is being increased to the same extent. This means that the time interval c is divided into equal time steps of for example 1 ms, 5 ms, 10 ms or 100 ms. In some embodiments, the additional torque provided by the electric motor is reduced from time step to time step. The real-time control strategy ensures that the sum M_{Soll} of the torque M_{EM} generated by the electric motor and the torque M_{VM} generated by the internal combustion engine remains constant, M_{Soll}=M_{VM}+M_{EM}. Thus the torque of the internal combustion engine is increased from time step to time step to the same extent as the torque M_{EM} of the electric motor is reduced. This control strategy naturally takes into account physical limits. This real-time control strategy described constitutes a very rapid, self-regulating system.

In some embodiments, sudden power increases of the internal combustion engine—which are particularly unfavorable with regard to emissions—can be avoided. The increase in torque generated by the internal combustion engine can thus be extended over time period c and hence slowed down. This guarantees a steady rise in power from the internal combustion engine. Nonetheless, the desired torque (corrected to the target torque) is immediately available. In some embodiments, only the torque proportion M_{EM} of the electric motor is controlled and calculated directly. This is now the reference variable. The internal combustion engine is automatically controlled indirectly by the relationship M_{Soll}=M_{EM}+M_{VM}.

Thus the calculation complexity is very low, whereby control is very fast, and also the fuel consumption or emissions can be optimized.

In some embodiments, the additional torque generated by the electric motor is reduced in linear fashion. This gives a triangular (linear) torque profile of the electric motor. This linear profile ensures that the torque gradient curve of the internal combustion engine is minimal. This control strategy is most favorable in relation to CO₂ and other emissions. However, other vehicle-specific functions for controlling the torque curve are conceivable.

In some embodiments, the time interval c is selected to be very short, for example in the range of less than 5 seconds or 3 seconds, less than 2 seconds, or less than 1 second. In this way, there is no need for a complex control system taking into account dynamic influencing variables. The real-time control strategy is therefore greatly simplified and possible for the first time.

In some embodiments, the method is performed automatically in the vehicle. In some embodiments, an engine control unit, which controls the power of the internal combustion engine and/or electric motor, performs the method. In some embodiments, the respective actual momentary status data of the internal combustion engine and electric motor are stored and processed in such an engine control unit. Also, suitable activation conditions for the method can be stored. The real-time control of the motors may take place in the engine control unit.

In some embodiments, the target torque is determined as a function of the required torque and the current status data of the internal combustion engine and electric motor. The operating range momentarily applied to the motors, and how much additional power is available, may also be taken into account. In some embodiments, the determined target torque does not exceed a maximal characteristic curve of the internal combustion engine. The maximal characteristic curve of the internal combustion engine may define the region in which the CO₂ emissions of the internal combustion engine are too high. With regard to CO₂ emissions, it is therefore sensible to limit the total torque of the internal combustion engine to this characteristic curve. In some embodiments, therefore the target torque is limited to the maximal characteristic curve of the internal combustion engine.

In some embodiments, the additional torque provided by the electric motor is reduced to zero within the predefined time interval c. At the end of the time interval C, the electric motor thus no longer supplies additional torque, while the internal combustion engine generates a torque which is increased by the difference Δ in comparison with before the torque request. The target torque is then generated completely by the internal combustion engine. Therefore it is useful to limit the target torque to the maximal characteristic curve of the internal combustion engine.

The predefined activation conditions may be fixedly set for a motor vehicle. For example, on production of the vehicle, factory-established activation conditions for a vehicle type may be predefined and preset. Predefined activation conditions may for example include predefined operating ranges in maps of the motors, i.e. of the internal combustion engine and/or electric motor. Other possible activation conditions may include permitted energy store states, i.e. the charge state of the battery, or states of driver's controls such as e.g. the vehicle pedals, injection quantities and their gradients, rotation speeds and speed changes. In an advantageous variant of the method, the predefined activation conditions are stored in the motor vehicle.

In the case of an additional power request by the driver or for example a driver assistance system, it is checked whether an activation condition is fulfilled. For this, current status data of the driver's controls and/or the internal combustion engine and/or the electric motor, or charge status data of an energy store, are compared with the activation conditions. If an activation condition is fulfilled, the method can be implemented. This is advantageously performed automatically by an engine control unit.

Also, the predefined time interval c for a motor vehicle may be a fixedly set value which was applied for example to a specific vehicle type. This could however also be stored as a characteristic curve, depending on vehicle status. Or the predefined time interval c may also be dynamically calculated and/or restricted in the vehicle, on the basis of current engine status data of the internal combustion engine and electric motor.

The operations of checking the activation conditions, and calculating and controlling the torques, may be separated from each other. Thus, the calculation complexity and hence the calculation time can be minimized or optimized. In some embodiments, a linear profile applies to the reduction of the additional torque (M_{EM}) provided by the electric motor within the predefined time interval c. This is implemented in the torque calculation. A linear profile means that the gradient remains constant over the time interval of length c. Component-induced limitations may however require a deviation from the preferred linear profile.

In some embodiments, a control device for a motor vehicle with a hybrid drive train with at least one internal combustion engine and an electric motor comprises a processor device configured to perform a method as described above. To this end, the processor device may comprise a microprocessor or a microcontroller. The method may be implemented as program code which can be executed by the processor device. The control device may comprise an engine control unit.

The control device may be configured to store and process momentary status data of the electric motor and internal combustion engine and driver influences, and to control the performance of the internal combustion engine and electric motor. Also, suitable activation conditions for the method according to the invention may be stored in the engine control unit. Thus, the control device has access to all data necessary for performance of the method.

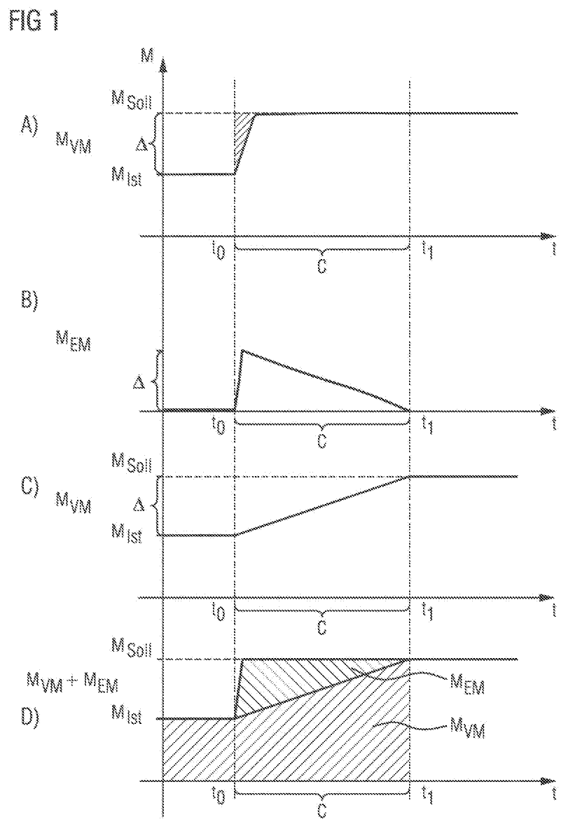

FIG. 1 shows torque curves of the internal combustion engine and electric motor at the top, over the time which is shown on the right. FIG. 1A shows the torque of the internal combustion engine M_{VM} with a value M_{Ist} before an additional torque request. The additional torque request is made in time t₀, for example by a driver pressing the accelerator pedal. This establishes a desired required torque M_{Wunsch} from which a target torque M_{Soll} is determined. Without the method according to the invention, the internal combustion engine torque M_{VM} would follow a relatively steep gradient in order to achieve the target torque M_{Soll}. This is unfavorable with regard to emissions, and also slightly slower than the power increase from an electric motor. The desired torque or the target torque is therefore only reached after a short delay, indicated here in exaggerated fashion by the hatched triangular area. The difference between the target torque M_{Soll} and the actual torque M_{Ist} is Δ.

FIG. 1B shows the torque curve of the electric motor M_{EM} when the method according to the invention is applied. Initially, the torque from the electric motor M_{EM} is zero since the vehicle is initially in the first operating mode. At time t0, the torque of the electric motor suddenly assumes value Δ. It is then reduced in linear fashion in the time interval c up to time t1. The associated curve of the internal combustion engine torque M_{VM} is shown in FIG. 1C. Initially, the torque M_{VM} is M_{Ist}.

From time t0 of the torque request, the torque is slowly increased by the difference Δ to the target torque over interval c up to time t1. The increase in internal combustion engine torque M_{VM} is therefore extended over the time interval c, in comparison with the curve without the method according to the invention as shown in FIG. 1A. The gradient is therefore less steep, whereby the emissions and CO₂ output are reduced.

FIG. 1D shows the total torque as the sum of the internal combustion engine torque M_{VM} and the electric motor torque M_{EM} following the method according to the invention. Starting from the actual torque of the internal combustion engine before time t0, the total torque is increased from the torque request at time t0 by the additional torque of the electric motor M_{EM} (shown as a hatched area) in a jump to the target torque. Over the time constant c, the proportion of the electric motor torque M_{EM} in the total torque becomes ever lower until the internal combustion engine alone again generates the full torque M_{Soll}. The delay indicated as a hatched area in FIG. 1A is here also reduced slightly, whereby the system performance as a whole is improved.

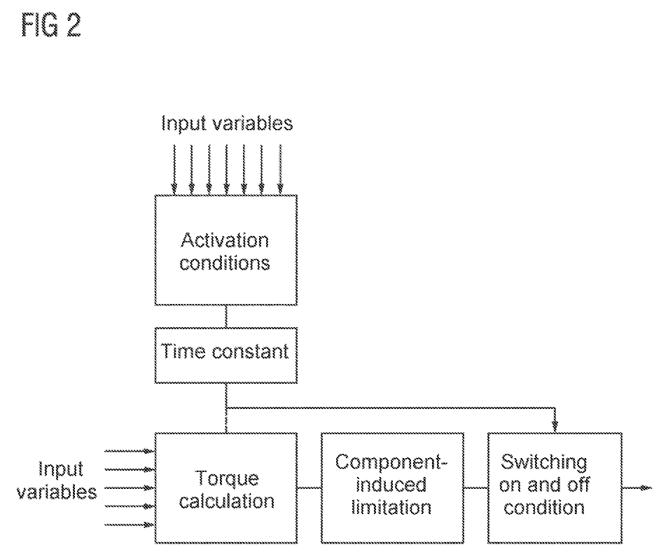

FIG. 2 shows as an example, in a block flow diagram, the sequence of the example method in the real-time control strategy. The input variables for the calculation are the momentary status data of the drive train assemblies (motor rotation speeds, injection quantities, injection gradients, actual torques), status data of controls (accelerator pedal position, accelerator pedal gradient, brake pedal state), and combinations thereof, and also the required torque M_{Wunsch} of the vehicle (which may be derived from said status data such as accelerator pedal position). These input variables define the “actual status” of the vehicle and are compared with the predefined activation conditions in order to decide whether the method according to the invention should be performed. If an activation condition is fulfilled, firstly the time constant c is sampled. This may be fixedly set as a constant for the vehicle or for example be calculated dynamically.

The actual calculation of the torque M_{EM} to be provided by the electric motor may be performed continuously during the real-time control process. The input variables are the momentary actual torque M_{Ist} provided by the internal combustion engine and electric motor, the momentary rotation speed, the required torque M_{Wunsch}, the state of charge of the vehicle battery (SOC), and limitations of the electric motor and internal combustion engine. From this, the torque to be momentarily provided by the electric motor is calculated; also, if an activation condition is fulfilled, the time constant c is used to calculate the gradient with which this additional torque M_{EM} must be reduced so that it can be decreased to zero within the time constant c. In the most favorable case, the reduction of the torque provided by the electric motor is linear over the time interval of length c, i.e. has a constant gradient.

Finally, further component-induced limitations are checked, and the calculated additional torque is made available by the electric motor by switch-on and switch-off conditions and reduced according to the calculated gradient. Component-induced limitations here may lead to deviations from the favored (e.g. linear) profile. As part of the real-time control strategy, the torque calculation is performed again for each time step. Since the calculation is essentially based on comparisons, it is not calculation-intensive and therefore is rapid, and thus allows a true real-time control for the first time.

What is claimed is:

1. A method for operating a motor vehicle having a hybrid drive train with an internal combustion engine and an electric motor, wherein a first operating state includes generating a drive torque solely by the internal combustion engine and a second operating state includes generating the drive torque using both the internal combustion engine and the electric motor, the method comprising:
defining a desired required torque in the first or second operating state in response to a momentary additional torque requirement and in the presence of a predefined activation condition;
determining a target torque depending on the required torque;
calculating a difference between the target torque and the momentarily provided actual torque;
initially generating an additional torque equivalent to the difference using the electric motor;
reducing the additional torque provided by the electric motor within a predefined time interval; and
increase a portion of the torque provided by the internal combustion engine to the same extent in the same time interval using a real-time control system.

2. The method for operating a motor vehicle as claimed in claim 1, wherein determining the target torque depends on the desired torque and momentary status data of at least one of: the internal combustion engine or the electric motor.

3. The method for operating a motor vehicle as claimed in claim 1, wherein the target torque is limited by a characteristic curve of the internal combustion engine.

4. The method for operating a motor vehicle as claimed in claim 1, further comprising reducing the additional torque provided by the electric motor to zero within the predefined time interval.

5. The method for operating a motor vehicle as claimed in claim 1, wherein the predefined activation condition for the motor vehicle is fixedly set.

6. The method for operating a motor vehicle as claimed in claim 1, wherein the predefined activation condition is defined by at least one condition chosen from the group consisting of: one or more predefined operating regions in maps of the internal combustion engine or electric motor, permitted energy store states, and pedal states or gradients.

7. The method for operating a motor vehicle as claimed in claim 1, wherein the predefined activation condition is stored in a memory of the motor vehicle;
further comprising, in response to an additional torque request, checking whether an activation condition is fulfilled wherein the momentary status data of the internal combustion engine and or electric motor, or current energy store status data are compared with the activation condition.

8. The method for operating a motor vehicle as claimed in claim 1, wherein
the predefined time interval is fixedly set for the motor vehicle.

9. The method for operating a motor vehicle as claimed in claim 1, further comprising calculating the predefined time based on momentary status data of at least one of the internal combustion engine or electric motor.

10. The method for operating a motor vehicle as claimed in claim 1, further comprising using a predefined a linear profile for the reduction of the additional torque provided by the electric motor within the predefined time interval.

11. A control device for a motor vehicle with a hybrid drive train having an internal combustion engine and an electric motor, the engine control device comprising:
a processor; and
a memory storing a set of instructions, the set of instructions, when loaded and executed by the processor, causing the processor to:
define a desired required torque in response to a momentary additional torque requirement and in the presence of a predefined activation condition;
determine a target torque depending on the required torque;
calculate a difference between the target torque and the momentarily provided actual torque;
initially generate an additional torque equivalent to the difference using the electric motor;
reduce the additional torque provided by the electric motor within a predefined time interval; and
increase a portion of the torque provided by the internal combustion engine to the same extent in the same time interval using a real-time control system.

12. The control device as claimed in claim 11, configured to:
store and process momentary status data of the electric motor and internal combustion engine; and
control the performance of the internal combustion engine and electric motor.

13. A motor vehicle comprising:
a hybrid drive train having an internal combustion engine and an electric motor;
a processor; and
a memory storing a set of instructions, the set of instructions, when loaded and executed by the processor, causing the processor to:
define a desired required torque in response to a momentary additional torque requirement and in the presence of a predefined activation condition;
determine a target torque depending on the required torque;
calculate a difference between the target torque and the momentarily provided actual torque;
initially generate an additional torque equivalent to the difference using the electric motor;
reduce the additional torque provided by the electric motor within a predefined time interval; and
increase a portion of the torque provided by the internal combustion engine to the same extent in the same time interval using a real-time control system.
